(19) United States
(12) Patent Application Publication
(10) Pub. No.: US 2012/0285821 A1
(43) Pub. Date: Nov. 15, 2012

(54) ELECTRODE SEPARATION TYPE WATER SOFTENING APPARATUS

(76) Inventor: Jong Gul Kim, Gumi-si (KR)

(21) Appl. No.: 13/518,844

(22) PCT Filed: Sep. 2, 2009
(86) PCT No.: PCT/KR10/05976

§ 371 Date: Jun. 22, 2012

(30) Foreign Application Priority Data
Sep. 2, 2009 (KR) 10-2009-0082474

(51) Int. Cl. C25B 9/08; C02F 5/00

(52) U.S. Cl. 204/263

(57) ABSTRACT

Provided is a high efficiency electrode separation type water softening apparatus which softens a common water with a hard water characteristic in such a way to separate and remove a positive ion component using an ion exchange membrane, and converts most of a common water into a soft water in such a way to have a positive ion component be absorbed by a small amount of water flowing via the interior of an ion exchange membrane while extending a lot an exchange period of an ion exchange membrane, so it can be used for a long time. The electrode separate type water softening apparatus comprises a chamber which has a hollow inner space, a certain length and a positive electrode member, thus supplying an electric current (+) to its inner side; a negative electrode member 40 which is formed at the center of the chamber in a longitudinal direction of the chamber, with an electric current (−) being applied thereto; an ion exchange membrane which is disposed between the negative electrode member and the positive electrode member; a first input port and a second input port which separately input hard water into the inner side and the outer side of the ion exchange membrane, respectively; and a first discharge port which discharges the hard water inputted in response to the first input port and the second input port to the outside of the chamber and discharges a positive ion concentrated water C, and a second discharge port which discharges a soft water.

### BACKGROUND OF THE INVENTION

The present invention relates to an electrode separation type water softening apparatus, and in particular to an electrode separation type water softening apparatus which makes it possible to produce a soft water using a common water and can be used for a long time by extending an exchange period of an ion exchange membrane in such a way that a positive ion component with a harder water characteristic such as Mg²⁺, Ca²⁺, Fe³⁺, etc. generally contained in a common water is separated by having it be absorbed by water flowing through the interior of an ion exchange membrane of the side of a negative ion electrode.

A common water such as underground water, etc. is a hard water containing a positive ion component such as Mg²⁺, Ca²⁺, Fe³⁺, etc. and the hard water generally generates a precipitate or scale which inhibits a normal flow of water in a pipe and inhibits the operation of a soap or a detergent, so the hard water is not proper for the purpose as a life water, an industrial water or a factory water.

It is needed to change the hard water to a soft water via a softening procedure for which a certain water softening apparatus with an ion exchange resin is generally used.

In the common soft softening apparatus, an ion exchange resin with negative ion characteristic is installed in the interior of a chamber with an input port and a discharge port. When a common water with a hard water characteristic is inputted via an input port, a positive ion component such as Mg²⁺, Ca²⁺, Fe³⁺, etc. is absorbed by an ion exchange resin, and the softened water is discharged via a discharge port, thus producing a soft water.

In the above mentioned softening apparatus, since an ion exchange resin used for a long time is all substituted with a hardness causing component, thus loosing an ion exchange function, as a result of which it is needed to recycle or exchange an ion exchange resin after a certain time of use or the use by a certain amount which causes bothersome. Since the recycling or exchange of an ion exchange resin is very short, it is needed to recycle or exchange frequently.

The supply of soft water might be stopped during a recycle or exchange period of an ion exchange resin, so a factory operation might be stopped.

### SUMMARY OF THE INVENTION

Accordingly, it is an object of the present invention to provide a high efficiency electrode separation type water softening apparatus which softens a common water with a hard water characteristic in such a way to separate and remove a positive ion component using an ion exchange membrane, and converts most of a common water into a soft water in such a way to have a positive ion component be absorbed by a small amount of water flowing via the interior of an ion exchange membrane while extending a lot an exchange period of an ion exchange membrane, so it can be used for a long time.

To achieve the above objects, there is provided an electrode separate type water softening apparatus, comprising a chamber 10 which has a hollow inner space, a certain length and a positive electrode member 11, thus supplying an electric current (+) to its inner side; a negative electrode member 40 which is formed at the center of the chamber 10 in a longitudinal direction of the chamber, with an electric current (−) being applied thereto; an ion exchange membrane 50 which is disposed between the negative electrode member 40 and the positive electrode member 11; a first input port 21 and a second input port 2 which separately input hard water into the inner side and the outer side of the ion exchange membrane 50, respectively; and a first discharge port 31 which discharges the hard water inputted in response to the first input port and the second input port to the outside of the chamber and discharges a positive ion concentrated water C, and a second discharge port 32 which discharges a soft water.

As a preferred overcoming means, the first input port 21 and the second input port 22 are disposed at an input plate 20 which is separable from one side of the chamber; and the first discharge port 31 and the second discharge port 32 are disposed at a discharge plate 30 which is separable from the other side of the chamber 10.

In addition, a disk 60 is installed at an inner side of each of the input plate 20 and the discharge plate 30, and the end portions of the both sides of the negative electrode member 40 and the ion exchange membrane 50 are fixed at a pair of the disks 60, so the ion exchange membrane 50 can be exchanged as the input plate 20 or the discharge plate 30 is separated from the chamber 10.

At this time, it is preferred that the ion exchange membrane 50 id disposed between the inner support net 51 and the outer support net 52 coming into contact with its inner and outer surfaces, respectively.

### BRIEF DESCRIPTION OF THE DRAWINGS

The present invention will become better understood with reference to the accompanying drawings which are given only by way of illustration and thus are not limitative of the present invention, wherein;

FIG. 1 is a cross sectional view illustrating a structure of an electrode separation type water softening apparatus according to the present invention;

FIG. 2 is an enlarged perspective and plane cross sectional view of the portion A of FIG. 1;

FIG. 3 is a view of a use state for explaining a positive ion separation operation based on a current application of an electrode separation type water softening apparatus according to the present invention; and

FIG. 4 is a view illustrating a connection construction of a state that an electrode separation type water softening apparatus is continuously installed according to the present invention.

### DESCRIPTIONS OF MAJOR ELEMENTS OF THE DRAWINGS

| 10: chamber | 11: positive electrode member |
|---|---|
| 20: input plate | |
| 21: first input port | 22: second input port |
| 30: discharge plate | |
| 31: first discharge port | 32: second discharge port |
| 40: negative electrode member | |
| 50: ion exchange membrane | |
| 51: inner side support net | 5: outer side support net |
| 60: disk | |
| H: hard water | C: concentrated water |
| S: soft water | V: flow valve |

### DETAILED DESCRIPTION OF THE INVENTION

The present invention will be described in details with reference to the accompanying drawings, and it is obvious that the structures of the accompanying drawings are only the illustrative purpose, so the present invention is not limited to the structure of the drawings.

The definitions of the terms of the elements shown in each drawing are not to limit the present invention, but are freely made for the descriptions of the present invention, so it is obvious that an ordinary person in the art can define other names.

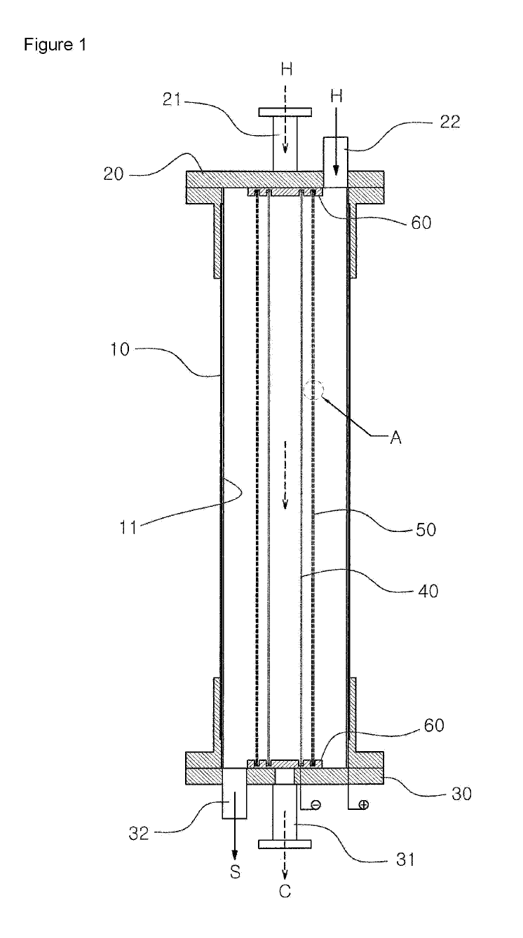

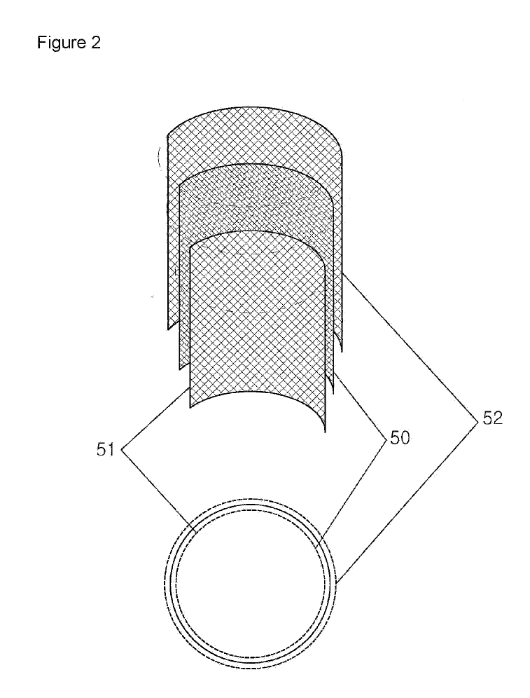

FIG. 1 is a cross sectional view illustrating a structure of an electrode separation type water softening apparatus according to the present invention, and FIG. 2 is an enlarged perspective and plane cross sectional view of the portion A of FIG. 1.

As shown in FIG. 1, the electrode separation type water softening apparatus according to the present invention comprises a hollow chamber 10, the chamber 10 having a certain length allowing the hard water to stay for a certain time in the interior and being made from a synthetic resin material such as PVC which does not conduct current.

A positive electrode member 11 is installed at an inner side of the chamber 10 for applying a current (+) by coating a conductive material such as copper, titanium, etc., which is separate from the chamber 10, and a rod-shaped negative electrode member 40 is installed at the center of the chamber 10 in a longitudinal direction of the chamber, and an electric cable is connected to the negative electrode member 40 for supplying the current (−).

An ion exchange membrane 50 is installed between the negative electrode member 40 and the positive electrode member 11 and is called a selective penetration membrane characterized in that the ion exchange resin is formed in a rod shape, and as an exchange membrane is input in an electrolyte solution and is used as a partition, and then current is applied to the solution, the ion exchange membrane (+) passes through a positive ion, but has almost 100% resistance to the passing of the negative ion (−), and the negative ion exchange membrane operates in a reverse way to the above position ion exchange membrane, in which operation the ions can be selectively penetrated.

The present invention is basically directed to eliminating positive ion components such as Mg²⁺, Ca²⁺, Fe³⁺, etc. from a hard water, so the ion exchange membrane is formed of a positive ion exchange membrane.

The first input port 21 and the second input port 22 are provided at one side of the chamber 10, and the first discharge port 31 and the third discharge port 32 are provided at the opposite side of the same. The first input port 21 and the first discharge port 31 communicate with the inner space of the ion exchange membrane 50, so the hard water H inputted in the first input port 21 flows through the inner space of the ion exchange membrane 50 and is discharged through the first discharge port 31.

The second input port 22 and the second discharge port 32 communicate with the outer space of the ion exchange membrane 50, so the hard water H inputted into the second input port 22 is discharged through the second discharge port 32 by way of the outer space of the ion exchange membrane 50.

It is preferred that the first input port 21 and the second input port 22 are formed at the input plate 20 which can be detachable at the front end of one side of the chamber 10, and the first discharge port 31 and the second discharge port 32 are formed at the discharge plate 30 which can be detachable at the front end of the other side of the chamber 10, so it is possible to separately discharge the input plate 20 or the discharge plate 30, if necessary, from the chamber 10, thus opening the interior of the chamber 10.

In this case, it is easy to wash or repair the interior of the chamber 10, and when the ion exchange membrane 50 or the negative electrode member 40 is damaged or has spent its service life, it is advantageous to recycle or exchange the same.

In a preferred form, a circular disk 60 is installed at each of the inner surfaces of the input plate 20 and the discharge plate 30, and the ends of both sides of the negative electrode member 40 and the ion exchange membrane 50 are fixed at a pair of the disks 60, respectively. When the input plate 20 of the discharge plate 30 is separated from the chamber 10, it is possible to concurrently remove both the negative electrode member 40 and the ion exchange membrane 50, which facilities an easier exchange of the same.

As shown in FIG. 2, since the ion exchange membrane 50 is made from a flexible material such as a fiber, it is preferred to provide a cylindrical inner support net 51 and a cylindrical outer support net 52 at the inner and outer surfaces of the ion exchange membrane 50 in order to keep a cylindrical shape in the ion exchange membrane 50. It is preferred that the inner support net 51 and the outer support net 52 both are made from a non-electrically conductive material such as a synthetic resin or a stainless, and the hole size formed at each of the support nets 51 and 52 is larger than or same as the hole size formed at the ion exchange membrane 50. When the hole formed at each of the support nets 51 and 52 is smaller than the hole formed at the ion exchange membrane 50, the function of the ion exchange membrane 50 might be worsened.

It was described in the above that the ion exchange membrane 50 is formed at the inner and outer support nets 51 and 52 in a dual cylindrical shape; however the present invention is not limited thereto. The ion exchange membrane 50 might be formed in various shapes in a rectangular shape or a triangle shape.

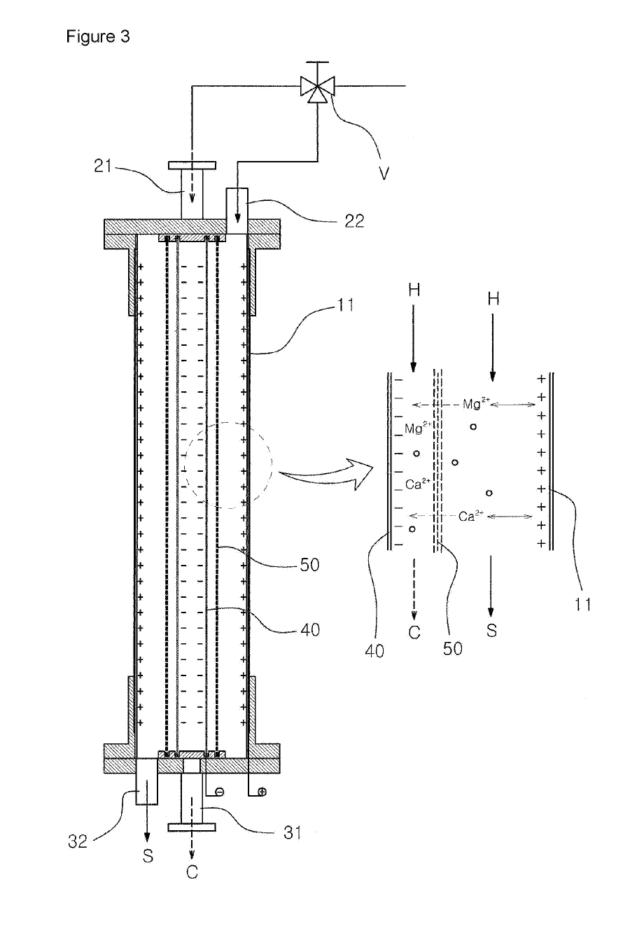

As shown in FIG. 3, the operation that a positive ion contained in a common water is absorbed by a hard water inputted via the first input port and is will be described, with operation of which the present invention will be more specified.

FIG. 3 is a view of a use state for explaining a positive ion separation operation based on a current application of an electrode separation type water softening apparatus according to the present invention.

As show in FIG. 3, a hard water H is inputted into both the first input port 21 and the second input port 22, and at the same time the current (−) is supplied to the positive electrode member 11, and the current (−) is supplied to the negative electrode member 40.

Mg²⁺, Ca²⁺, etc. contained in the hard water H flowing via the outer space of the ion exchange membrane 50 have the same poles as the positive electrode member 11, thus generating a repulsive force between the same, and have the poles different from the negative electrode member 40, thus generating an attractive force between the same, so it moves toward the inner space of the ion exchange membrane 50.

At this time, the ion exchange membrane 50 allows a positive ion to pass operating as a positive ion exchange membrane, and allows a negative ion not to pass, so the positive ion is eliminated from the water flowing to the outer space of the ion exchange membrane 50, thus producing a soft water S, and the soft water is discharged through the second discharge port 32 for the purpose of a commercial use.

In addition, the positive ion contained in the water flowing via the inner space of the ion exchange membrane 50 increases, thus producing a concentrated water, and the concentrated water C is discharged through the first discharge port 31 as sewage. The concentrated water C might be processed as a sewage water through a certain treatment process or might be reused.

As shown in FIG. 3, the first input port 21 and the second input port 22 might be connected with the flow amount valve V so as to adjust the input amount of the hard water H into each input port 21, 22. The input amount ratio of the hard water into each of the first input port 21 and the second input port 22 is 5˜10% at the side of the first input port 21 assuming that the total input amount is 100%, and is 90˜95% at the side of the second input port 22.

Here the input amount ration of the hard water might be adjusted without installing a flow amount valve V, for example, it is possible to adjust the input amount of the hard water H by designing the diameters of the first input port 21 and the second input port 22 to be different.

When the amount of the hard water H inputted into the first input port 21 is adjusted to be smaller, the amount of the water to be converted into the concentrated water C can be minimized, and on the contrary, it is possible to convert 90˜95% of the hard water into the soft water, which means that the softening efficiency with respect to the input amount of hard water can be increased.

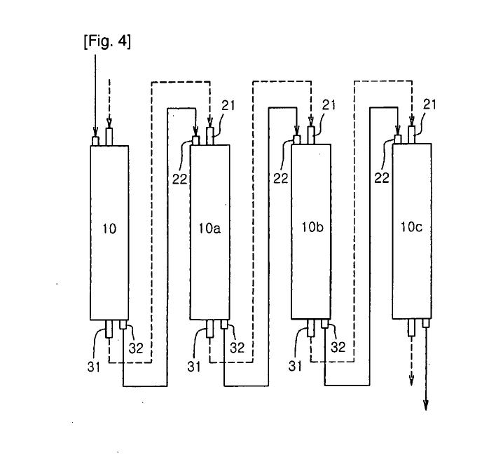

FIG. 4 is a view illustrating a connection state that an electrode separation type water softening apparatus according to the present invention is continuously installed, in which it is possible to produce pure soft water from which most of positive ions are removed.

As shown in FIG. 4, the chamber 10 might be installed along with a second chamber 10a, a third chamber 10b, and a fourth chamber 10c each having the same constructions. Here, the first discharge port of each chamber is connected with the first input port of the neighboring chamber, and the second discharge port of each chamber is connected with the second input port of the neighboring camber, so a plurality of chambers are connected in series.

The first discharge port 31 of the chamber 10 is connected with the first input port 21 of the neighboring second chamber 10a, and the second discharge port 32 of the chamber 10 is connected with the second input port 22 of the neighboring second chamber 10a, which consequently forms a serial connection. In this case, since the hard water H passes through multiple water softening apparatuses in sequence, the efficiency of water softening can be maximized.

The present invention has been described with reference to the structures shown in the drawings according to an embodiment of the preset invention. The present invention is not limited to the disclosed invention, and various materials except for the disclosed materials can be selected and used as long as it has the same function and object, and it is obvious that an ordinary person in the art can change or modify with the equivalent means with reference the above disclosure, and such changes or modifications are within the scope of the present invention.

In the present invention, an ion exchange membrane is installed near an electrode rod (−) installed in the interior of the water softening apparatus, and a common water is inputted by a proper separate amount into the inner and outer sides of the ion exchange membrane, and here 5˜10% of the water is inputted into the inner side, and 90˜95% of the water is inputted into the outer side, so the positive ion components contained in a common water can be absorbed by a small amount of water, and are discharged. So, water softening can be performed without losing the common water, which results in a higher water softening efficiency. The life span of the product can be extended as the exchange period of the ion exchange membrane is a lot extended.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An electrode separate type water softening apparatus, comprising:
a chamber (10) which has a hollow inner space, a certain length and a positive electrode member (11), thus supplying an electric current (+) to its inner side;
a negative electrode member (40) which is formed at the center of the chamber (10) in a longitudinal direction of the chamber, with an electric current (−) being applied thereto;
an ion exchange membrane (50) which is disposed between the negative electrode member (40) and the positive electrode member (11);
a first input port (21) and a second input port (2) which separately input hard water into the inner side and the outer side of the ion exchange membrane (50), respectively; and
a first discharge port (31) which discharges the hard water inputted in response to the first input port and the second input port to the outside of the chamber and discharges a positive ion concentrated water (C), and a second discharge port (32) which discharges a soft water.

2. The apparatus of claim 1, wherein said first input port (21) and said second input port (22) are disposed at an input plate (20) which is separable from one side of the chamber; and the first discharge port (31) and the second discharge port (32) are disposed at a discharge plate (30) which is separable from the other side of the chamber (10).

3. The apparatus of claim 2, wherein a disk (60) is installed at an inner side of each of the input plate (20) and the discharge plate (30), and the end portions of the both sides of the negative electrode member 40 and the ion exchange membrane (50) are fixed at a pair of the disks (60), so the ion exchange membrane (50) can be exchanged as the input plate (20) or the discharge plate (30) is separated from the chamber (10).

4. The apparatus of claim 1, wherein an inner support net (51) and an outer support net (52) both formed in a net shape are formed at an inner surface and an outer surface of the ion exchange membrane (50) for thereby supporting the ion exchange membrane (50), respectively.

5. The apparatus of claim 4, wherein the sizes of the net holes of the inner support net (51) and the outer support net (52) are same as or larger than the hole sizes of the ion exchange membrane.

6. The apparatus of claim 1, wherein said first input port (21) and said second input port (22) each include a flow amount valve (V) for thereby adjusting the amount of the hard water (H) inputted into the first input port (21) and the second input port (22).

7. The apparatus of claim 1, wherein the input amount ratio of the hard water of the flow amount valve V is 5˜10% at the side of the first input port (21) with respect to the total input amount and is 90˜95% at the side of the second input port (22).

8. The apparatus of claim 1, wherein said chamber (10) is provided in multiple numbers, and the first discharge port of each chamber is connected with a first input port of the neighboring chamber, and a second discharge port of each chamber is connected with a second input port of the neighboring chamber.

9. The apparatus of claim 3, wherein an inner support net (51) and an outer support net (52) both formed in a net shape are formed at an inner surface and an outer surface of the ion exchange membrane (50) for thereby supporting the ion exchange membrane (50), respectively.

10. The apparatus of claim 6, wherein the input amount ratio of the hard water of the flow amount valve V is 5˜10% at the side of the first input port (21) with respect to the total input amount and is 90˜95% at the side of the second input port (22).

11. The apparatus of claim 2, wherein said chamber (10) is provided in multiple numbers, and the first discharge port of each chamber is connected with a first input port of the neighboring chamber, and a second discharge port of each chamber is connected with a second input port of the neighboring chamber.

12. The apparatus of claim 3, wherein said chamber (10) is provided in multiple numbers, and the first discharge port of each chamber is connected with a first input port of the neighboring chamber, and a second discharge port of each chamber is connected with a second input port of the neighboring chamber.
